(19) United States
(12) Patent Application Publication
(10) Pub. No.: US 2013/0036017 A1
(43) Pub. Date: Feb. 7, 2013

(54) Financial card for online fund transfer and method therefor

(71) Applicant: Ivason Galloway, Miami, FL (US)

(72) Inventor: Ivason Galloway, Miami, FL (US)

(21) Appl. No.: 13/136,596

(22) Filed: Aug. 5, 2011

(51) Int. Cl. G06Q 40/00; G06K 5/00; G06K 19/073; G07F 19/00

(52) U.S. Cl. 705/16; 235/379; 235/381; 235/380; 235/492; 705/44; 705/42

(57) ABSTRACT

Disclosed is a financial card comprising of at least a user identification means including but not limited to a fingerprint recognition scanner and at least a data transfer protocol, and optionally an iris pattern scanner. Also disclosed is a method for transferring funds from a first financial card to a second financial card comprising (a) activating at least one of said first and second financial cards by an user identification means including but not limited to a provided finger print recognition scanner, and upon successful verification of the user's identity; (b) engaging the data transfer protocol.

### FIELD OF THE INVENTION

The present invention relates to a financial card. More particularly, the present invention relates to a financial card and a method for transferring financial information from one financial card to another without using an automatic teller machine or visiting bank wherein the transaction is permitted after an authentic user identification.

### BACKGROUND OF THE INVENTION

Online transferring of the funds from one account to another is an efficient way offering the advantage of being convenient and time saving. The credit or debit cards have been widely used for payment, deposit, transfer and the like through an online system in financial institutions such as a bank and a credit company. The data for identifying a customer, such as a secret number, is magnetically stored in the magnetic card. The technology used for the online transfer has evolved over a period of time.

Electronic payments are convenient payment options that avoid the need to write checks, swiping credit/debit cards or handling paper money. The electronic payment mechanisms involve entering user identification information into the web browsers to effect the transactions. However, these electronic payments do not come without substantial concerns regarding the privacy and definite possibility of identity theft and consequent financial frauds. It is desirable to inculcate safeguards into the electronic payment mechanisms and credit/debit cards to protect sensitive personal information from falling prey to fraudulent behavior.

One of the most prevalent methods for defending a user against financial frauds is installing virus protection software and firewalls on the computer. However, it is not always possible to install anti-virus software on credit/debit cards.

Moreover, the electronic payment mechanisms are not always preferred by the consumers as being too time consuming and due to the problem of remembering a different login and password for every credit/debit card. It is thus desirable to provide a financial card having an inbuilt security feature that avoids the need to remember an inconvenient plurality of login and passwords for each account.

U.S. Pat. No. 4,001,550 relates to a universal funds transfer and identification card having a plurality of fields of changeable information, selectively addressable, so that the information in selected fields may be read by a terminal for obtaining from the card information necessary for completing a transaction, and may be written into by the terminal for updating the account status. The technology taught in the said patent facilitates the transaction after PIN (personal identification number) recognition that could be easy to be stolen and can cause tremendous harm and hence is a weak security measure. PIN numbers stored in scrambled configuration have the disadvantage of being forgotten or being decrypted using software. The card is susceptible to being misused once the card PIN is stolen or compromised. It is desirable to provide a financial card that facilitates card-card transaction after a fail-proof recognition that is unique to each person thereby providing strong security measure. The security feature provided in a financial card is desirable to be fail-proof and preferably be more secure than using a scrambled PIN. Moreover, it is often seen that people tend to reuse the same pin number over and over for easy of remembering thus creating a potential for security breach. It is desirable to provide a financial card that further raises the bar on security.

U.S. Pat. No. 4,498,000 relates to a security method and device for confidential data communication in digital form via intermediate stages; it applies to systems which allow data exchange between bearers of crediting means and centralized processing machines via specific independent non-supervised terminal units. More particularly, the invention makes it possible to identify, approve and possibly encode exchanges of data between an authorized bearer of a crediting means and a remote centralized processing machine via an independent specific terminal unit, so as to preserve the confidential nature of the private data when indiscretion is to be feared. This patent does not teach a financial card that facilitates card-card transaction after a fail-proof recognition that is unique to each person thereby providing strong security measure. It is desirable to provide a financial card that enables financial transactions in a more robust manner without the possibility of potential financial misuse.

U.S. Pat. No. 4,650,981 relates to an interactive credit card including intelligent circuitry and read/write data storage. It does not disclose a financial card that enables compromise-proof identification of the authentic user of the card prior to every financial transaction that further enhances the security in financial transactions.

U.S. Pat. No. 4,736,094 provide a financial transaction processing system capable of performing a transaction with a desired transaction account using only a single integrated circuit, even if the customer has a plurality of transaction accounts at a plurality of financial institutions, whereby complexity in handling and managing a plurality of cards can be eliminated. The negative with having multiple accounts on one card is that once the intruder gains an “entry point” access to the card, the intruder can compromise all the accounts, which can be a financially dangerous situation. Thus, it is desirable to provide a financial card having a multitude of identification means that is unique to each individual thereby negating the chances of any possible financial fraud.

U.S. Pat. No. 4,874,935 relates to a smart card apparatus and a method for programming the same. More particularly, the present invention relates to a smart card apparatus and method for programming same with an open architecture approach. The security measures used in the taught technology is storing personalized data on the card that includes data field ID, a length of field, and data attribute that are again does not offer security at par with the security identification contemplated according to the instant invention.

U.S. Pat. No. 5,478,993 relates to a process that provides a staggered degree of security as a safety concept against unauthorized use of a transaction card for purchasing of items. The card has four memories memorizing an amount of money, a money installment and its limiting value, a number of usable transactions and its limiting value, further data for doing an identity check of the ownership of the cardholder and also an authenticity check. The card is usable at three different types of payment instruments with or without an identity check and/or an authenticity check. Further, U.S. Pat. No. 5,786,587 relates to a method of enhancing the security of a chip card that contains an integrated circuit including a changeable memory and a write once/read only memory. It has been found that the security measure of prompting a card holder for second information eventually gets recycled so many times that eventually this data is so widespread in databases everywhere, that this in itself is a security problem. With the advent of the powerful search engines on the internet such as Google, social networking sites such as facebook and other online search resources, second information can be easy found out at the click of a mouse. This “second information” such as user's “mother's maiden name”, “place of birth” “date of birth” and the typical questions used to derive this information are also known by people close to the user making the user susceptible to fraud and identity theft. It has been documented that most identity theft victims fall victims to some they know or someone very close to them. Unscrupulous vendors could potentially also misuse this “second information”. There is thus a dire need for a financial card which authorizes a financial transaction after positive user identification so that the possibility of a fraudulent financial transaction without the authentic user's approval is eliminated.

These patents discussed hereinabove teach various technologies adopted for the online transfer and security. Despite the implementation of utmost security, there are cases of online transfer frauds that affect the safety and to some extent are the pull factors for not using these technologies. Moreover, the technologies taught in the prior art enable only a two-way transaction pattern from card to terminal or vice versa but does not enable a multiple transaction pattern between card to card, card to terminal or terminal to card financial transaction.

Therefore, there exists a need within the art for a financial card and a method that overcomes at least the aforesaid shortcomings of the prior art by including fingerprints or iris recognition as the security authorization means, which are unique for each individual, thereby minimizing any possibility of a financial fraud, that facilitates card to card or terminal to card transfer thereby providing “many to many” transaction pattern. These and other advantages of the present invention are realized in the manner described hereinafter.

### SUMMARY OF THE INVENTION

According to an aspect of the present invention, there is provided a financial card comprising at least a user identification means and at least a data transfer protocol.

According to another aspect of the present invention, there is provided a method for transferring funds from a first financial card to a second financial card, said method comprising:
(a) activating at least one of said first and second financial cards by a provided user identification means, and upon successful verification of the user's identity;
(b) engaging the data transfer protocol.

These and other aspects and embodiments thereof are described in exemplary details hereunder, which are not to be construed as limiting.

### ADVANTAGES OF THE INVENTION

Accordingly, an advantage of the present invention is a financial card that is activated by the fingerprint authorization wherein any transaction is permitted only after a successful unique identification thereby offering enhanced security.

Another advantage of the present invention is an efficient measure for dealing with online fund transfer frauds thereby providing a fail-proof security for preventing financial frauds.

Another advantage of the present invention is a financial card that facilitates card to card or terminal to card transfer thereby providing “many to many” transaction pattern.

Yet another advantage of the present invention is in providing a secure anywhere banking wherein a user can effect secure transfer of funds from a first financial card to a second financial card instantly.

Further advantage of the present invention is to provide a method for the transfer of funds from a first financial card to a second financial card without the need for visiting an automatic teller machine (ATM), the card issuing bank or its website.

Another advantage of the present invention is to provide a financial card and a method that provides instant fund transfer with enhanced impenetrable financial security to the cardholder.

### BRIEF DESCRIPTION OF THE DRAWINGS

The invention will now be described in connection with the drawings described hereinafter.

FIG. 1 illustrates the front view of the financial card comprising the fingerprint recognition and iris recognition biometrics and other features according to an embodiment of the present invention.

FIG. 2 illustrates the rear view of the financial card comprising data transfer protocol and other features according to an embodiment of the present invention.

FIG. 3 explains the functioning of the financial card using the data transfer protocol according to an embodiment of the present invention.

FIG. 4 illustrates the application of financial card in automatic teller machine according to an embodiment of the present invention.

FIG. 5 illustrates the application of financial card in credit card machine according to an embodiment of the present invention.

FIG. 6 illustrates the application of financial card in mobile phone according to an embodiment of the present invention.

FIG. 7 illustrates the application of financial card in web according to an embodiment of the present invention.

FIG. 8 illustrates the application of financial card in vending machine according to an embodiment of the present invention.

FIG. 9 illustrates the application of financial card at a point of sale terminal according to an embodiment of the present invention.

FIG. 10 is a schematic representation of the fund transfer from one financial card to another.

FIG. 11 illustrates the “one to one” transaction pattern of the prior art.

FIG. 12 illustrates the “many to many” transaction pattern contemplated according to the present invention.

### PARTICULAR ADVANTAGES OF THE INVENTION

There is provided a financial card comprising a fingerprint recognition scanner and a data transfer protocol such that a transaction is only activated following an unique user identification. The financial card may be incorporated within another device such as a computer, touch-screen devices, mobile phones, computers, social media, televisions, cash registers, kiosks, vending machines, point of sale devices and automatic teller machines. In one aspect, the financial card includes two or more secure identification means for the identification of a user. In addition to the fingerprint identification, here is provided a handwriting scanner, hand and finger geometry scanner, voice print scanner, iris scanner and/or vein geometry scanner. In one aspect, the financial card has a mobile data transfer device to communicate over a wired or wireless communication means directly with the banking website, banking host, cloud computer or a bank intranet without linking-up to an automatic teller machine or a computer.

### DETAIL DESCRIPTION OF THE INVENTION

Therefore, the present invention provides a financial card comprising at least an user identification means and at least a data transfer protocol.

The user identification means of the present invention enables a secure identification of an user without possibility of a compromise. As used herein, the term “user identification means” of the present invention shall be defined to mean identification of an user using at least, or alternatively, a plurality of scanners selected from fingerprint recognition scanner, handwriting scanner, facial recognition scanner, hand geometry scanner, finger geometry scanner, voice print scanner, iris pattern scanner and vein geometry scanner.

In an embodiment, the user identification means of the present invention is a fingerprint scanner. The fingerprint scanner of the instant invention is capable of obtaining an image of a user's finger and determining whether the fingerprint pattern i.e. the pattern of ridges and valleys in the imaged finger matches the pattern in the pre-scanned image. The pre-scanned image is typically the fingerprint pattern of an authentic user of the financial card. A financial transaction is authorized only if the fingerprint of the user matches the pre-scanned image stored in the financial card.

The fingerprint recognition scanner of the present invention may be an optical fingerprint scanner or capacitive fingerprint scanner. In an embodiment, an optical scanner comprises an array of light sensitive diodes or photosites, which generate an electric signal in response to photons being incident thereon. Each photosite is made capable of recording a pixel, which may be a light pixel or a dark pixel. An array of light and dark pixels forms an image of the finger, which is thereafter compared with the pre-scanned image of an authentic user's fingerprint for authentication.

In an embodiment, the fingerprint scanner of the present invention is a capacitive fingerprint scanner. Each capacitive scanner comprises an array of cells, each cell having two conductor plates covered with an insulator. A finger placed on the scanner for identification forms the third capacitive plate. The pattern of ridges and valleys on the finger alters the capacitance of the cell thereby altering the voltage output for the ridges and valleys. The pattern of ridges and valleys closely reflects the fingerprint pattern, which is then compared with the pre-scanned fingerprint image stored on the financial card of the instant invention to authenticate a requested financial transaction.

In another embodiment, the user identification means of the present invention comprises handwriting recognition scanner. The handwriting recognition scanner of the present invention includes a touch sensitive writing surface and a pen that is capable of detecting the angle, pressure and direction of an user's handwriting. The handwriting scanner thereafter draws the detected angle, pressure and direction into a graph, compares the graph with a pre-stored graph and allows a financial transaction in the event of two graphs matching each other.

In an embodiment, the user identification means of the present invention comprises a hand and finger geometry scanner to authenticate a requested financial transaction. The hand and finger geometry scanner flat glass plate on which an user is requested to place his hand, a provided camera pictures the hand to determine the length, width, thickness and curvature of the hand and fingers, converts the detected information into a template and compares the template with a pre-selected template prior to a requested financial transaction.

In another embodiment, the user identification means of the present invention is a voiceprint scanner. The voiceprint scanner plots a spectrograph on being fed a voice sample, compares the plotted spectrograph with a pre-defined spectrograph and authenticates a requested financial transaction in the event the plotted spectrograph matches with the stored spectrograph.

In another embodiment, the user identification means of the present invention comprises an iris pattern scanner. The iris pattern scanner of the present invention locates the center and edge of the pupil and the edge of the iris, eyelids and eyelashes, analyzes the patterns in the iris and determines a code using the scanned information. The determined code is thereafter compared to predetermined code and a requested financial transaction is authenticated subsequent to a match between the determined and the predetermined codes.

In an embodiment, the user identification means of the present invention comprises a vein geometry scanner to authenticate a requested financial transaction. The vein geometry scanner plots a template of the shape and location of a user's vein structure to a template and compares the plotted template with a pre-selected template prior to a requested financial transaction. A requested financial transaction is authenticated subsequent to a match between the determined and the predetermined vein geometry templates.

In another embodiment, the user identification means comprises a facial recognition scanner. The facial recognition scanner measures one or more features of a face selected from distance between the eyes, width of the nose, depth of the eye sockets, shape of the cheekbones and/or the length of the jawline and creates a faceprint of the imaged face. The faceprint is thereafter compared with a stored faceprint and a requested financial transaction is authenticated subsequent to a match between the determined and predetermined faceprint.

It should be noted however that the user identification means of the present invention may be used as such available, the fabrication and function of which is not a criticality of the present invention.

The present invention therefore utilizes an user identifications means according to the present invention as a transaction authorization mechanism thereby ruling out the possibility of an identity fraud as the detected characteristic patterns are unique markers for an individual. In the event of a successful authentication, the financial card of the present invention engages a data transfer protocol.

The data transfer protocol of the present invention enables communication of information between the financial card and a banking website, banking host, cloud computer or a bank intranet or between two cards or between the banking website, banking host, cloud computer or a bank intranet and the card. The data transfer protocol of the present invention may be a first generation data protocol, second generation data protocol, general packet radio service protocol, enhanced data GSM environment (EDGE protocol) and/or 3G protocols such as universal mobile telecommunication service, wide code division multiple access protocol, high speed downlink packet access or evolution data maximized protocol. The data transfer protocol of the present invention is not particularly limiting and is not a criticality. In an embodiment, the data transfer protocol includes sequential generational protocols such as 2G, 3G, 4G and future protocol generations.

In another embodiment, the financial card comprises a mobile data transfer device. Upon successful identification of a user, the provided mobile data transfer device communicates with one or more banking websites to authenticate one or more requested fund transfers. The data transfer device is preferably provided with a light emitting diode (LED) that glows to a “green” color signifying a data transfer in progress. Therefore, in this embodiment, the financial card of the present invention communicates over a wired or wireless communication means directly with the banking website, banking host, cloud computer or a bank intranet without linking-up to an automatic teller machine or a computer. These mobile transfer devices and LEDs are conventionally known in the art and may be used as such available.

In an embodiment, the financial card of the present invention is provided with a bluetooth communication device. The provided bluetooth communication device identifies other financial card in proximity to the user's financial card and allows fund transfer between the two cards in proximity on successful identification. These Bluetooth communication devices are conventionally known in the art and may be used as such available. The word “proximity” is intended herein to mean a distance of from about 10 meters to about 100 meters, which allows the data transfer protocol to be engaged between a plurality of financial cards of the present invention.

In an embodiment, the financial card of the present invention may be a card including but not limited to, an automated teller machine readable card, a credit card, a charge card or a debit card.

In embodiment, the financial card of the present invention includes at least a fingerprint recognition scanner or an iris recognition scanner and at least another different identification means selected from fingerprint recognition scanner, iris scanner, handwriting scanner, hand and finger geometry scanner, voice print scanner, face pattern recognition scanner and vein geometry scanner. These scanner types are conventionally known in the art and may be used as such available.

The financial card of the present invention comprises a camera. The provided camera may be equipped to record any transaction by recording pictures and/or videos of the transaction. In this embodiment, the secure identification means identifies an user and allows a transaction only if the identified user has an account with the issuing bank. These iris scanner and cameras for iris pattern recognition are conventionally known in the art and may be used as such available.

In an embodiment, the financial card of the present invention comprises a screen, which displays information relating to the fund transfer to the user. These screens are conventionally known in the art and may be used as such available. Preferably, the screen may be a light emitting diode screen, which is conventionally known in the art.

In another embodiment, the financial card of the present invention comprises a keypad. The provided keypad allows a user to enter information on being prompted by the financial card to do so. These keypads are conventionally known in the art and may be used as such available.

In an embodiment, the financial card of the present invention comprises a card identification mechanism that identifies another card when any two cards are brought into close proximity. Upon successful confirmation by a user, the card identification mechanism initiates the data transfer protocol authorizing a fund transfer from the first financial card to the second financial card account. In this embodiment, the card identification mechanism notifies both the parties involved in the transaction that the fund transfer has been completed. Preferably, the parties involved are notified regarding the completion of a fund transfer by email or short message servicing.

In an embodiment, the card identifications mechanism comprises an embedded microprocessor, which is capable of communicating with another microprocessor embedded into another financial card using a data transfer protocol. The microprocessor comprises data stored therein including information identifying an user's identity and/or user's banking information such as bank account numbers, credit card numbers, debit card numbers and charge card numbers.

In an embodiment, the microprocessor is under a gold contact pad on one side of the card.

In this embodiment, the financial card of the present invention comprises storage means for storing information identifying the plurality of payee, payor, vendor or vendee involved in a transaction. The stored information may be retrieved to authorize payments subsequently upon being authorized by a user to do so. These storage means are conventionally known in the art and may be used as such available.

In an embodiment of the present invention, the financial card of the present invention may be adapted to store information identifying multiple accounts of a user including accounts jointly held by the user with other individuals. In an embodiment, the financial card of the present invention may be adapted to require authentication by the individual fingerprints of the joint account holders prior to authenticating a requested financial transaction.

In an embodiment, the term “fund” or “funds” as used herein is intended to include money in the form of local or foreign currency, mutual equity fund or debt fund units, commercial papers, government bonds, treasury bills, liquid funds, equity shares, exchange traded funds and commodity traded funds.

The financial card of the present invention comprises a magnetic stripe in addition to an embedded microprocessor. The magnetic stripe includes information identifying the user, one or more merchants, valid card number, expiration date, credit card limits and information identifying the card usage. Magnetic stripes are conventionally known in the art and may be used as such available.

In another embodiment, the financial card of the present invention may be incorporated within another device such as a computer, touch-screen devices, mobile phones, computers, social media, televisions, cash registers, kiosks, vending machines, point of sale devices and automatic teller machine.

In another embodiment, the financial card of the present invention additionally includes one or more solar cells, which power the functionalities of the financial card. The solar power collected may be stored in a provided battery or a capacitor, both of which form alternate embodiments of the instant invention. These solar cells are conventionally known in the art and may be used as such available.

In yet another aspect, the present invention provides a method for transferring funds from a first financial card to a second financial card comprising (a) activating at least one of said first and second financial cards by a user identification means, and upon successful verification of the user's identity; (b) engaging the data transfer protocol. As used herein, the term “user identification means” of the present invention shall be defined to mean identification of an user using at least, or alternatively, a plurality of scanners selected from fingerprint recognition scanner, handwriting scanner, facial recognition scanner, hand geometry scanner, finger geometry scanner, voice print scanner, iris pattern scanner and vein geometry scanner.

In an embodiment, the method of the present invention prompts a user to enter the amount to be transferred, and upon receipt of an input amount from the user, prompts the first and second card holders to place their predetermined fingers on the fingerprint recognition scanners provided on said first and second cards. Upon successful identification of the first and second users, the financial cards prompt their respective users to bring said first and second cards into close proximity. Upon successful verification of the user's identity, the transaction is initiated by engaging the data transfer protocol on the card. In the event of an unsuccessful identification, the transaction is promptly cancelled.

In this embodiment, the data transfer protocol is intended to have the same meaning as the meaning intended according to any previous aspect or embodiment thereof.

In an embodiment, the method of the present invention comprises initiating a data transfer protocol when a first financial card is brought into close proximity to a second financial card. Upon successful identification of a user, the provided mobile data transfer device communicates with one or more banking websites to authenticate one or more requested fund transfers. The data transfer device is preferably provided with a light emitting diode that glows to a “green” color signifying a data transfer in progress.

In an embodiment, the user identification means of the invention comprises at least a fingerprint scanner and/or or an iris scanner and at least another identification means selected from fingerprint recognition scanner, handwriting scanner, facial recognition scanner, hand geometry scanner, finger geometry scanner, voice print scanner, iris pattern scanner and vein geometry scanner.

In an alternate embodiment, the method of the present invention comprises establishing a wireless bluetooth communication between a first and a second financial card in close proximity to each other. In the event of a successful identification, the method comprises allowing fund transfer between the two cards in proximity. In the event of an unsuccessful identification, the transaction is promptly cancelled.

In this embodiment, a successful identification by one or more users whose cards are brought into close proximity triggers a web-based transfer protocol authorizing a fund transfer from the first financial card to the second financial card. The method includes identifying both the parties involved in the transaction that the fund transfer has been completed by email or short message servicing.

In yet another embodiment, the method of the present invention comprises storing information identifying the plurality of payee, payor, vendor or vendee involved in a transaction. The stored information may be retrieved to authorize payments subsequently upon being authorized by a user to do so.

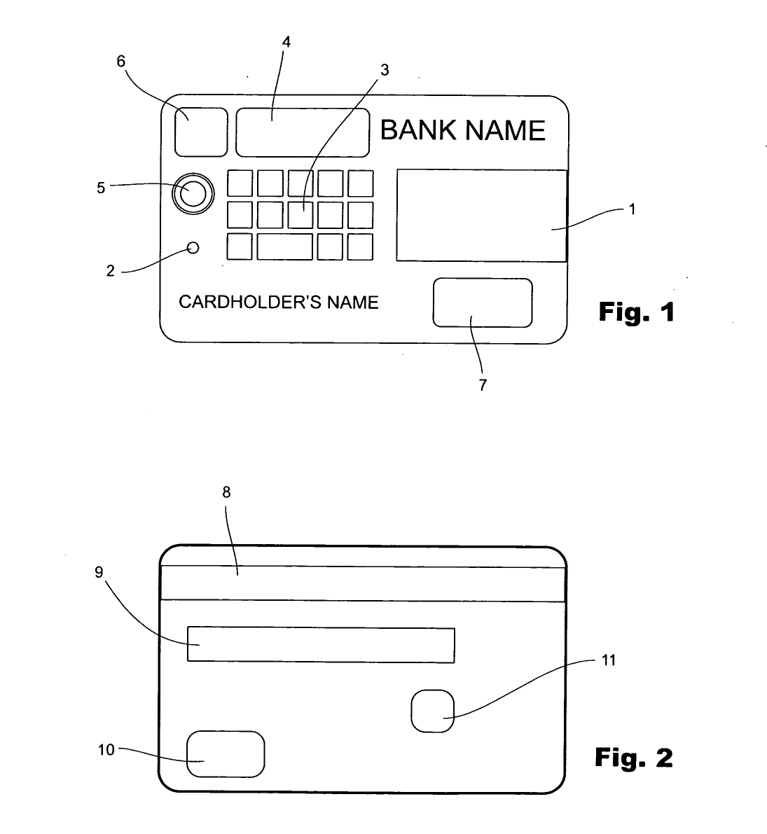

FIG. 1 illustrates the front view of an exemplary embodiment of a financial card comprising fingerprint recognition and iris recognition biometrics and other features according to the present invention. The finger print recognition biometric scanner 1 is activated by finger print recognition. Financial card includes a means 2 that sends data over the internet when the card is activated by the fingerprint. Upon activation, the financial card prompts the user to enter the amount of funds that he wishes to be transferred to a predetermined account. The user enters the amount through a provided keypad 3 which is displayed on a provided screen 4. The camera 5 has an iris recognition biometrics that also recognizes the user. However, it should be understood that the term “Internet” is not intended to be limiting. In an alternate embodiment, the financial card may communicate with one or more banking websites or any intranet, cloud computer network or any other hosting website using wired or wireless communications means. Exemplary wired or wireless communications means include cable, internet, intranet, networked computers, mobile networks etc., all of which are intended to be included within the scope of the present invention. Additionally, the financial card of the present invention is provided with solar cell 6 in this embodiment of the present invention. Additionally, the financial card comprises a hologram, preferably a 3-D hologram 7 of the card issuing bank in order to enhance the security of the card.

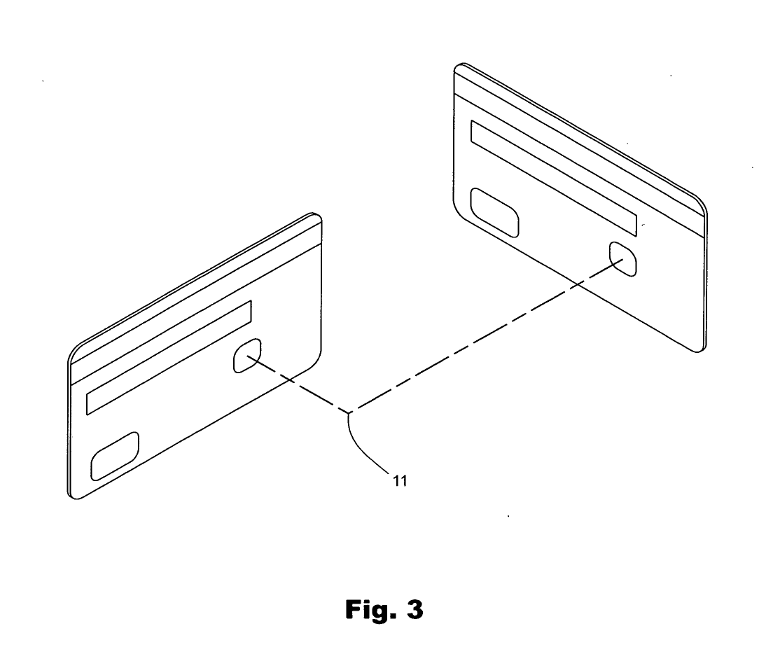

FIG. 2 illustrates the rear view of the financial card comprising the magnetic strip 8, signature bar 9, the card issuer's hologram 10 and the card identification means 11. The card identification means 11 identifies another card when any two cards are brought into close proximity and initiates the web-based data transfer protocol authorizing a fund transfer from the first financial card to the second financial card account.

FIG. 3 explains the functioning of the financial card using the data transfer protocol according to an embodiment of the present invention. The financial cards are activated after successful fingerprint scanner identification and a data transfer protocol is initiated after a successful identification.

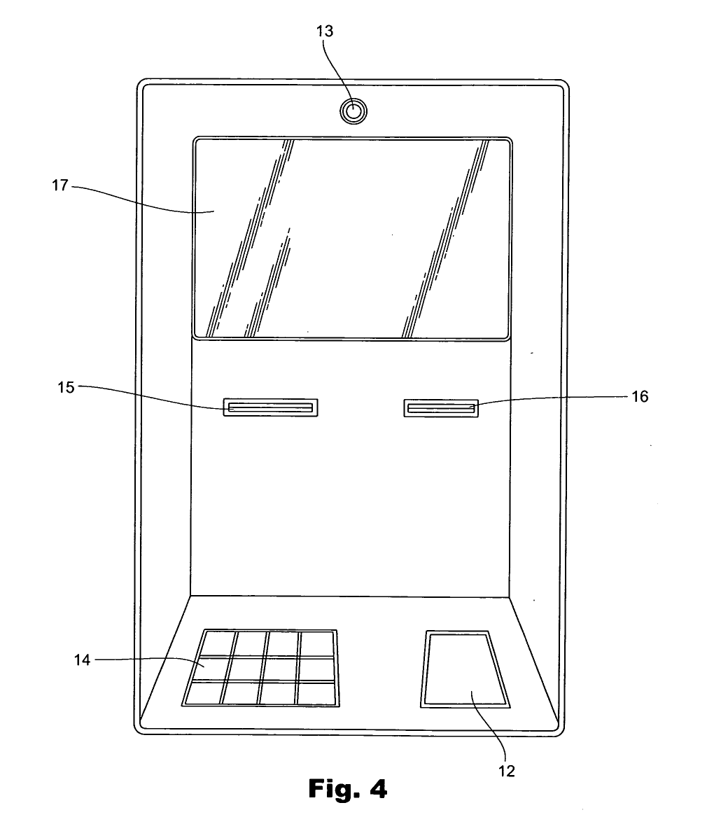

FIG. 4 illustrates the application of financial card in an automated teller machine (ATM) according to an embodiment of the present invention. The automatic teller machine comprises at least a fingerprint recognition scanner 12 and a camera 13 for iris recognition scanning. The conventional features present in the automatic teller machine according to an embodiment of the present invention include a keyboard 14, cash deposit 15, check deposit slot 16 and a screen 17.

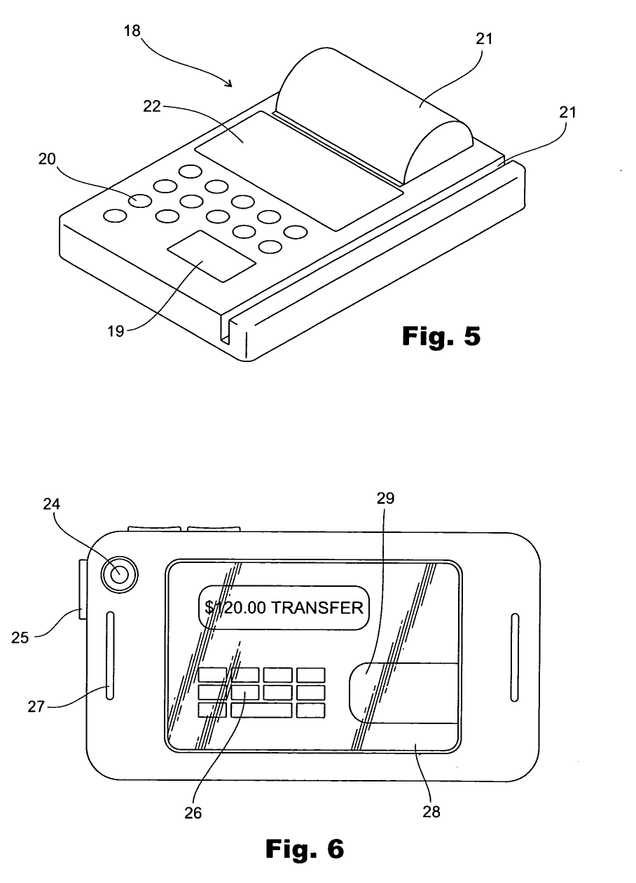

FIG. 5 illustrates the application of financial card in credit card machine according to an embodiment of the present invention. The credit card machine 18 according to this embodiment of the invention comprises a fingerprint recognition scanner 19, a key pad 20, a card swiping slot 21, a touch-screen interface 22 and a receipt printer 23. The credit card machine allows a transaction only after successful fingerprint scanner identification.

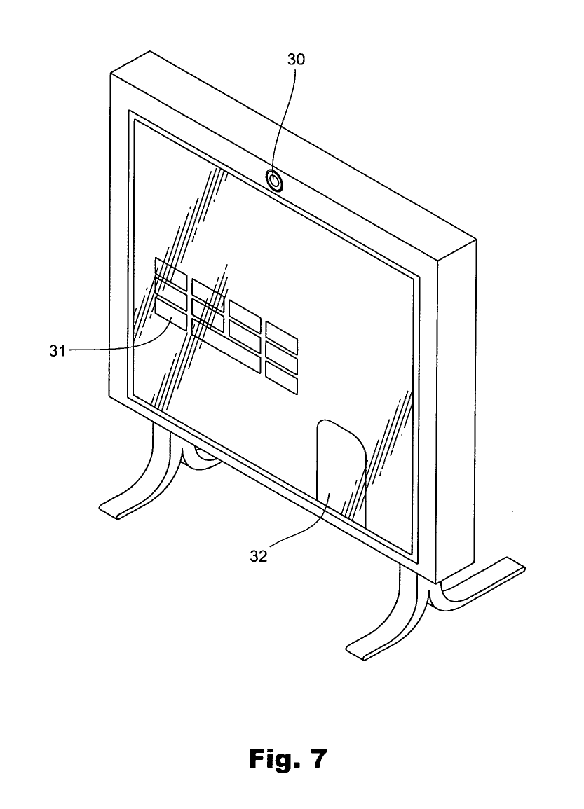

FIG. 6 illustrates the application of financial card in mobile phone according to an embodiment of the present invention. The mobile phone comprises a camera 24 for iris identification, an antenna 25 for data transfer, a keyboard 26 (which is an on-screen keyboard), an ear piece 27, a screen 28, a microphone and a fingerprint recognition scanner 29. The mobile phone allows a transaction only after successful fingerprint scanner identification.

FIG. 7 illustrates the application of financial card in web according to an embodiment of the present invention. In this web-based embodiment, the invention provides a touch-screen display comprising a web-camera 30 for iris identification, an on-screen touch-screen keyboard 31 and an on-screen fingerprint scanner 32. The touch-screen display allows a transaction only after successful fingerprint scanner identification.

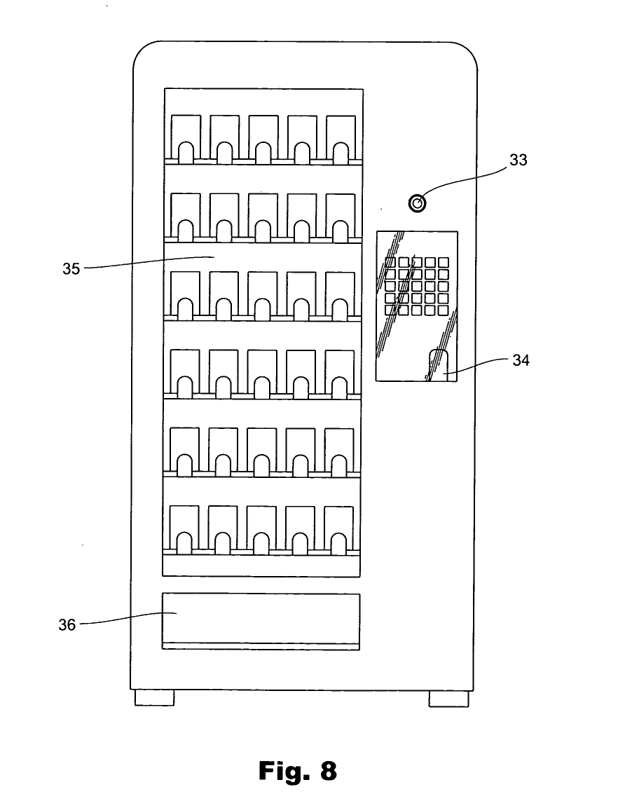

FIG. 8 illustrates the application of financial card in vending machine according to an embodiment of the present invention. The vending machine according to an embodiment comprises an iris scanner (33), a fingerprint scanner (34), a product display (35) and a product dispenser (36). In this embodiment, the purchase is authorized only after a successful fingerprint authorization or eye pattern authorization by the iris scanner.

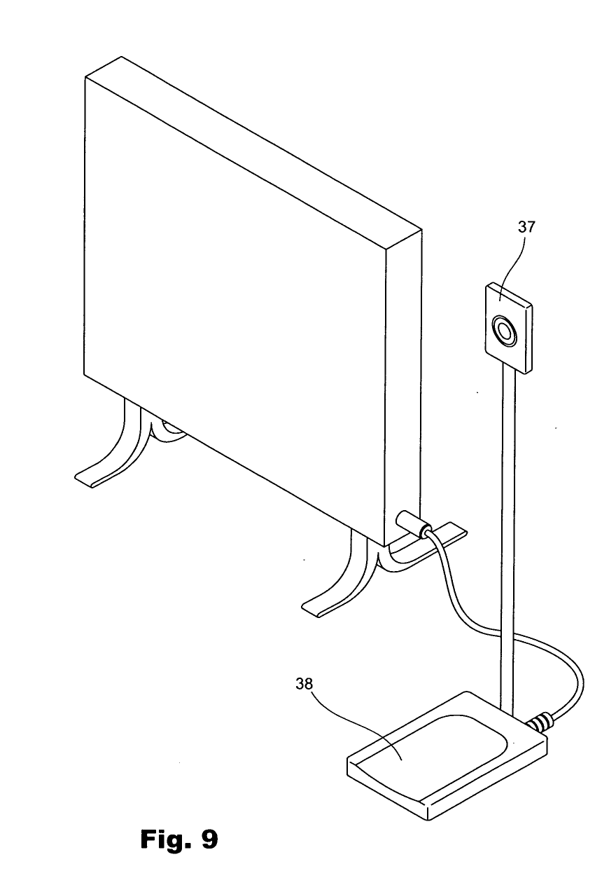

FIG. 9 illustrates the application of financial card at a point of service(POS) terminal according to an embodiment of the present invention. The POS retrofit according to the instant embodiment comprises an iris scanner 37 and a fingerprint scanner 38 connected to a POS terminal (not shown). The POS terminal allows a transaction only after a positive fingerprint scanning authorization and optionally, after a successful iris pattern recognition.

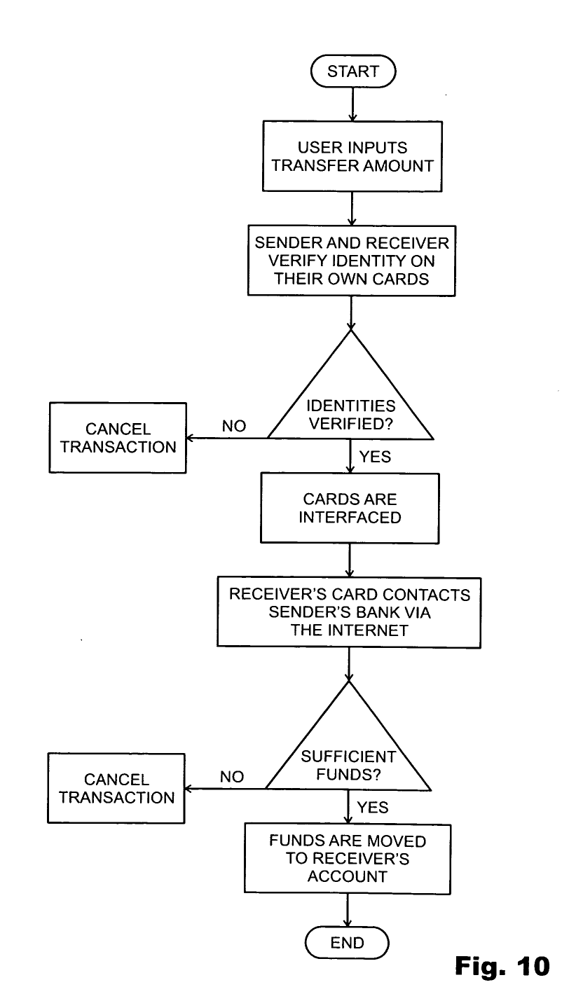

FIG. 10 is a schematic representation of the fund transfer mechanism from one financial card to another financial card. It illustrates the method of fund transfer according to the present invention wherein user inputs the requested transfer amount and thereafter the sender and receiver verify identity on their own cards. If the identity is not verified, transaction is cancelled whereas on a successful verification of identity, a transaction is processed by interaction between the cards. The receiver's card contacts the sender's bank via internet and confirms the completion of the transaction. The transaction is then processed and funds are transferred to receivers account in case of sufficient funds being available in the sender's account.

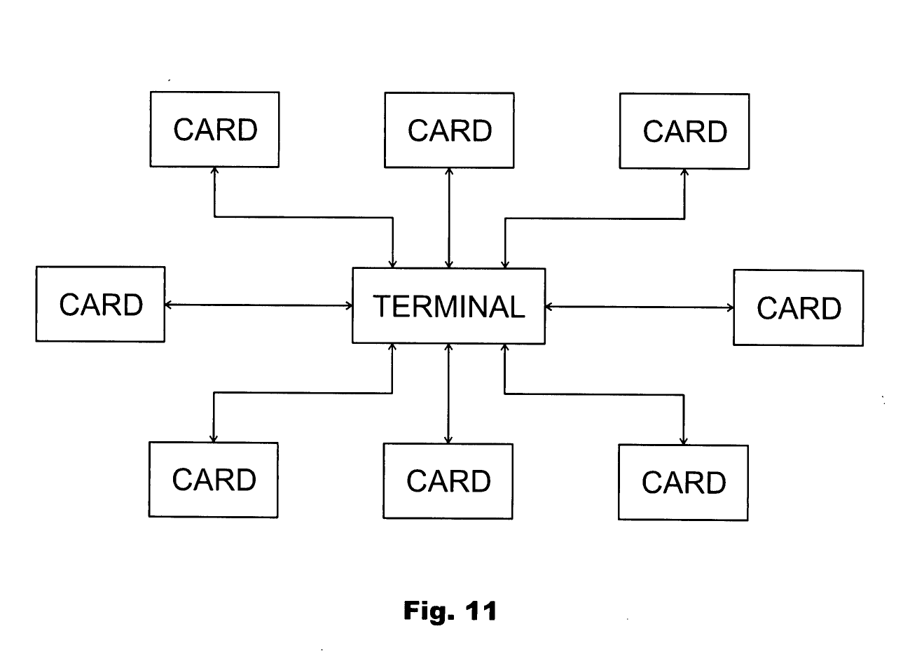

FIG. 11 illustrates the “two way” transaction pattern of the prior art that involves card to terminal or terminal to card transaction.

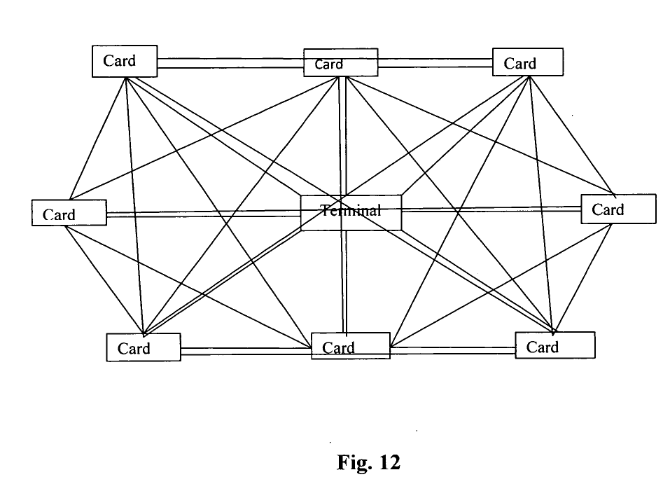

FIG. 12 illustrates the “multiple” transaction pattern contemplated according to the present invention that involves card to card, card to terminal or terminal to card financial transaction.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for transferring funds from a first financial card to a second financial card, said method comprising (a) activating at least one of said first and second financial cards by a provided user identification means, and upon successful verification of the user's identity; (b) engaging the data transfer protocol.

2. The method as claimed in claim 1 comprising (a) prompting an user to enter the amount to be transferred, and upon receipt of an input amount from the user; (b) prompting a first and second card holders to authenticate themselves using the user identification means of their respective cards, and upon successful identification of the first and second users; (c) prompting the first and second financial card users to bring said first and second cards into close proximity; and (d) engaging the data transfer protocol.

3. The method as claimed in claim 1 or claim 2 comprising communicating with one or more banking websites to authenticate one or more requested fund transfers.

4. The method as claimed in claim 3, wherein said communication is carried out using a wired or wireless communication means with a banking website, banking intranet, cloud computer network or a hosting website.

5. The method as claimed in claim 1 or claim 2, comprising security identification using an iris scanner.

6. The method as claimed in claim 5, wherein said step of security identification using an iris scanner comprises taking a picture of the iris with a provided camera, analyzing the patterns in the iris and confirming the identity of a user using the analyzed iris patterns.

7. The method as claimed in claim 1 or claim 2 comprising establishing a bluetooth communication between a first and a second financial card in close proximity to each other, and in the event of a successful identification, allowing fund transfer between the two cards in proximity.

8. The method as claimed in claim 7, wherein allowing a fund transfer between two cards in proximity comprises triggering a web-based transfer protocol authorizing a fund transfer from the first financial card to the second financial card in the event of a successful identification by one or more proximate card users.

9. The method as claimed in claim 1 or claim 2 comprising notifying both the parties involved in the transaction that the fund transfer has been completed by email or short message servicing.

10. A method for transferring funds from a first financial card to a second financial card, said method comprising (a) activating at least one of said first and second financial cards by a user identification means selected from fingerprint recognition scanner, handwriting scanner, facial recognition scanner, hand geometry scanner, finger geometry scanner, voice print scanner, iris pattern scanner and vein geometry scanner, and upon successful verification of the user's identity; (b) engaging the data transfer protocol.

11. A method for transferring funds from a first financial card to a second financial card, said method comprising (a) activating at least one of said first and second financial cards by a user identification means selected from a fingerprint recognition scanner or an iris pattern scanner; (b) re-authenticating the identified user of at least one of said first and second financial cards using another different user identification means selected from fingerprint recognition scanner, handwriting scanner, facial recognition scanner, hand geometry scanner, finger geometry scanner, voice print scanner, iris pattern scanner and vein geometry scanner, and upon successful verification of the user's identity; (c) engaging the data transfer protocol.

12. A financial card comprising at least one user identification means selected from fingerprint recognition scanner, handwriting scanner, facial recognition scanner, hand geometry scanner, finger geometry scanner, voice print scanner, iris pattern scanner and vein geometry scanner; and at least a data transfer protocol.

13. The financial card as claimed in claim 12, wherein said fingerprint recognition scanner is an optical scanner or a capacitance scanner.

14. The financial card as claimed in claim 12 comprising at least another different secure identification means for the identification of an user selected from a fingerprint recognition scanner, handwriting scanner, facial recognition scanner, hand geometry scanner, finger geometry scanner, voice print scanner, iris pattern scanner and vein geometry scanner.

15. The financial card as claimed in claim 12 comprising a camera adapted to take a picture of the iris of a user, analyze the patterns in the iris and confirm the identity of a user using the analyzed patterns.

16. The financial card as claimed in claim 15, wherein said camera is adapted to record a transaction by recording pictures and/or videos of the transaction.

17. The financial card as claimed in claim 12 comprising a screen which displays information relating to the fund transfer to the user.

18. The financial card as claimed in claim 12 comprising a keypad allowing an user to enter information on being prompted by the financial card.

19. The financial card as claimed in claim 12 comprising a mobile data transfer device capable of communicating with one or more banking websites to authenticate one or more requested fund transfers.

20. The financial card as claimed in claim 19, wherein said financial card communicates with one or more banking websites directly through a wired or wireless communication means without connecting to an intermediate computer or an automated teller machine (ATM).

21. The financial card as claimed in claim 12, additionally comprising a solar cell.

22. The financial card as claimed in claim 12 comprising a bluetooth communication device adapted to identify other financial card in proximity to the user's financial card and allows fund transfer between the two cards in proximity on successful identification.

23. The financial card as claimed in claim 12 comprising a card identification means adapted to identify another card when any two cards are brought into close proximity and initiate a web-based data transfer protocol authorizing a fund transfer from the first financial card to the second financial card account.

24. The financial card as claimed in claim 12 comprising of a storage means for storing information identifying the plurality of payee, payor, vendor or vendee involved in a transaction.

25. The financial card as claimed in claim 12 comprising a magnetic stripe adapted to store information identifying the user, one or more merchants, valid card number, expiration date, credit card limits and information identifying the card usage.

26. A financial card comprising: (a) at least one user identification means selected from fingerprint recognition scanner, handwriting scanner, facial recognition scanner, hand geometry scanner, finger geometry scanner, voice print scanner, iris pattern scanner and vein geometry scanner; (b) at least another different user identification means selected from fingerprint recognition scanner, handwriting scanner, facial recognition scanner, hand geometry scanner, finger geometry scanner, voice print scanner, iris pattern scanner and vein geometry scanner; and (c) at least a data transfer protocol.

27. The financial card as claimed in claim 26, wherein said data transfer protocol enables communication of information between the financial card and a banking website, banking host, cloud computer or a bank intranet or between two cards or between the banking website, banking host, cloud computer or a bank intranet and the card.

28. The financial card as claimed in claim 27, wherein said data transfer protocol is selected from a first generation data protocol, second generation data protocol, general packet radio service protocol, enhanced data GSM environment (EDGE protocol) and/or 3G protocol, 4G protocol, 5G protocol and other sequential protocols.

29. The financial card as claimed in claim 28, wherein said 3G data transfer protocol is selected from universal mobile telecommunication service, wide code division multiple access protocol, high speed downlink packet access or evolution data maximized protocol.

30. The financial card as claimed in claim 26 comprising a card identification mechanism that identifies another card when any two cards are brought into close proximity.

31. The financial card as claimed in claim 30, wherein said card identification mechanism is an embedded microprocessor.

32. An automatic teller machine vending machine comprising a financial card as claimed in claim 12 or claim 26.

33. A credit card swiping machine comprising a financial card as claimed in claim 12 or claim 26.

34. A mobile communication device comprising a financial card as claimed in claim 12 or claim 26.

35. A web portal utilizing a financial card as claimed in claim 12, said web portal utilizing at least a fingerprint recognition scanner or an iris pattern recognition scanner or claim 26.

36. A vending machine comprising a financial card as claimed in claim 12 or claim 26.

37. A point of service (POS) terminal connected to a financial card as claimed in claim 12 or claim 26.
